(19) United States
(12) Patent Application Publication
(10) Pub. No.: US 2022/0056246 A1
(43) Pub. Date: Feb. 24, 2022

(54) METHOD FOR PRODUCING CHLOROPRENE POLYMER LATEX

(71) Applicant: SHOWA DENKO K.K., Tokyo (JP)

(72) Inventors: Noriko OGAWA, Tokyo (JP); Masanao KAMIJO, Tokyo (JP)

(73) Assignee: SHOWA DENKO K.K., Tokyo (JP)

(21) Appl. No.: 17/418,529

(22) PCT Filed: Dec. 10, 2019
(86) PCT No.: PCT/JP2019/048316

§ 371 Date: Jun. 25, 2021

(30) Foreign Application Priority Data
Dec. 27, 2018 (JP) 2018-245756

(51) Int. Cl. C08L 11/02; C08F 2/26; C08F 36/18; C08K 5/42

(52) U.S. Cl. CPC C08L 11/02; C08F 2/26; C08L 2201/52; C08K 5/42; C08L 2203/02; C08F 36/18

(57) ABSTRACT

The present invention relates to a method for producing a chloroprene polymer latex, comprising: adding (B) a sodium. salt of a naphthalene sulfonate formaldehyde condensate and. (C) sodium dodecylbenzenesulfonate to a monomer solution that contains (A-1) 2-chloro-1,3-butadiene (chloroprene) or a monomer solution that contains (A-1) 2-chloro-1,3-butadiene (chloroprene) and (A-2-1) 2,3-dichloro-1,3-butadiene, and performing polymerization. Consequently, the present invention enables the production of a chloroprene polymer latex which is suppressed in aggregates that are generated during the production of a chloroprene polymer latex having a high solid content.

### TECHNICAL FIELD

The present invention relates to a chloroprene polymer latex and a method for producing the same. In further detail, the present invention relates to a chloroprene polymer latex that is suppressed in aggregates generated during the production by using a combination of new dispersants, and a method for producing the same. The chloroprene polymer latex obtained by the method according to the present invention is suitably used in dip-molded products such as gloves, bladders of blood pressure gauges, and. rubber threads, as well as in asphalt modifiers, adhesives, pressure-sensitive adhesives, and waterproofing agents, and is particularly suitably in medical gloves.

### BACKGROUND ART

Conventionally, chloroprene polymer latexes have been broadly used for example in dip-molding applications such as gloves, pressure-sensitive adhesive/adhesive applications, and civil engineering and construction applications such as elastic asphalt (modified asphalt), and elastic cement, due to their good properties such as general rubber physical properties, weatherability, heat resistance, and chemical resistance. However, aggregates generated during polymerization have been problematic particularly from the viewpoint or productivity of dip-molded products.

As a technique related to the present invention, JP H11-502889 A (Patent Literature 1) discloses a chloroprene latex polymer composition particularly for adhesives, prepared by emulsion polymerization. Patent Literature 1, however, neither describes nor suggests the generation of aggregates.

### CITATION LIST

### Patent Literature

Patent Literature 1: JP H11-502889 A (U.S. Pat. No. 5,773,544 A)

### SUMMARY OF INVENTION

### Technical Problem

The object of the present invention is providing a method for producing a chloroprene polymer latex, in which the generation of aggregates is suppressed during the production of a chloroprene polymer latex having a high solid content, which is preferred from the viewpoints of productivity, usability, and transportation.

### Solution to Problem

As a result of earnest studies to achieve the above object, the present inventors have found that by simultaneously using specific 2 types of emulsifiers, the generation of aggregates can be suppressed even for the production of a chloroprene polymer latex having a high solid concentration, thereby completing the present invention.

Namely, the present invention relates to a method for producing a chloroprene polymer latex as described in [1] to [6] below.

[1]

A method for producing a chloroprene polymer latex, comprising: adding (B) a sodium salt of a naphthalene sulfonate formaldehyde condensate and (C) sodium dodecylbenzenesulfonate to a monomer solution that contains (A-1) 2-chloro-1,3-butadiene (chloroprene) or a monomer solution that contains (A-1) 2-chloro-1,3-butadiene (chloroprene) and (A-2-1) 2,3-dichloro-1,3-butadiene, and performing emulsion polymerization.

[2]

The method for producing a chloroprene polymer latex described in [1], wherein the addition amount of the (B) sodium salt of a naphthalene sulfonate formaldehyde condensate is 0.3 parts by mass or higher and 2.0 parts by mass or lower relative to the feed amount of all the monomers of 100 parts by mass.

[3]

The method for producing a chloroprene polymer latex described in [1] or [2], wherein the addition amount of (C) sodium dodecylbenzenesulfonate is 0.01 parts by mass or higher and 0.2 parts by mass or lower relative to the feed amount of all the monomers of 100 parts by mass.

[4]

The method for producing a chloroprene polymer latex described in any one of [1] to [3], wherein an anionic surfactant is used as an emulsifier.

[5]

The method for producing a chloroprene polymer latex described in any one of [1] to [4], wherein a rosin acid soap that is a rosin acid saponified with an excess amount of sodium hydroxide and/or potassium hydroxide is used as an emulsifier.

[6]

The method for producing a chloroprene polymer latex according to any one of [1] to [5], wherein the monomer solution further contains (A-2-2) another monomer that is copolymerizable with (A-1) 2-chloro-1,3-butadiene (chloroprene).

### Advantageous Effects of Invention

The present invention enables the production of a chloroprene polymer latex in which the generation of aggregates is suppressed even at a high solid concentration. Due to its high latex amount per volume, the chloroprene polymer latex according to the present invention enables the highly efficient production of dip-molded products such as gloves, bladders of blood pressure gauges, and rubber threads by a dip-molding method.

### DESCRIPTION OF EMBODIMENTS

Embodiments of the present invention are described in detail below.

Chloroprene polymer latexes, which are produced by the production method according to the present invention, are polymer latexes comprising chloroprene as a main monomer component. The polymer latexes as such are specifically (1) a homopolymer latex of (A-1) 2-chloro-1,3-butadiene (chloroprene); (2) a copolymer latex of (A-1) chloroprene and (A-2-1) 2,3-dichloro-1,3-butadiene; (3) a copolymer latex of (A-1) chloroprene, (A-2-1) 2,3-dichloro-1,3-butadiene, and (A-2-2) another monomer; and (4) a copolymer latex of (A-1) chloroprene and (A-2-2) another monomer. In the present specification including the claims, the term “the chloroprene polymer latex” means the above polymer latexes (1) to (4).

[(A-2-1) 2,3-dichloro-1,3-butadiene]

According to the present invention, (A-2-1) 2,3-dichloro-1,3-butadiene is preferably contained as another monomer component. forming the chloroprene polymer latex. During the copolymerization, the ratio of (A-1) chloroprene to (A-2-1) 2,3-dichloro-1,3-butadiene is, in % by mass, preferably 100.0:0.0 to 70.0:30.0, more preferably 100.0:0.0 to 75.0:25.0, and still more preferably 100.0:0.0 to 80.0:20.0. When the ratio is within the above range, polymer crystallization is suppressed, and good flexibility is obtained.

[(A-2-2) Another Copolymerizable Monomer]

According to the present invention, (A-2-2) another copolymerizable monomer that may be contained in (A) a chloroprene polymer forming a chloroprene polymer latex is a monomer that is copolymerizable with (A-1) chloroprene and (A-2-1) 2,3-dichloro-1,3-butadiene above. Specific examples are 1-chloro-1,3-butadiene, butadiene, isoprene, styrene, acrylonitrile, acrylic acid and the esters thereof, and methacrylic acid and the esters thereof. The ratio of (A-1) chloroprene to the (A-2-2) copolymerizable monomer is, in % by mass, preferably 100.0:0.0 to 90.0:10.0, more preferably 100.0:0.0 to 92.0:8.0, and still more preferably 100.0:0.0 to 94.0:6.0.

[(B) A Sodium Salt of a Naphthalene Sulfonate Formaldehyde Condensate and (C) Sodium Dodecylbenzenesulfonate]

The process for producing the (A) chloroprene polymer according to the present invention is preferably performed via aqueous emulsion polymerization.

According to the present invention, (B) a sodium salt of a naphthalene sulfonate formaldehyde condensate and (C) sodium dodecylbenzenesulfonate as emulsifiers for the emulsion polymerization are added to a monomer solution containing (A-1) 2-chloro-1,3-butadiene (chloroprene) or a monomer solution containing (A-1) 2-chloro-1,3-butadiene (chloroprene) and (A-2-1) 2,3-dichloro-1,3-butadiene, and the polymerization is performed.

By adding (B) a sodium salt of a naphthalene sulfonate formaldehyde condensate and (C) sodium dodecylbenzenesulfonate, the generation of aggregates is suppressed even during the production of a chloroprene polymer latex having a high solid content, and good moldings are obtainable by a dip-molding method.

The addition amount of (B) a sodium salt of a naphthalene sulfonate formaldehyde condensate is preferably 0.3 parts by mass or higher and 2.0 parts by mass or lower, more preferably 0.4 parts by mass or higher and 1.2 parts by mass or lower, and still more preferably 0.5 parts by mass or higher and 0.8 parts by mass or lower relative to the total amount of (A-1) 2-chloro-1,3-butadiene (chloroprene), (A-2-1) 2,3-dichloro-1,3-butadiene, and (A-2-2) another monomer, namely the feed amount of all the monomers of 100 parts by mass. When the addition amount is within the above range, polymerization is performed without the generation of aggregates.

The addition amount of (C) sodium dodecylbenzenesulfonate is, relative to the feed amount of ail the monomers of 100 parts by mass, 0.01 parts by mass or higher and 0.2 parts by mass or lower, preferably 0.02 parts by mass or higher and 0.15 parts by mass or lower, more preferably 0.03 parts by mass or higher and 0.13 parts by mass or lower, and still more preferably 0.04 parts by mass or higher and 0.12 parts by mass or lower.

When the addition amount is within the above range, bubbling is suppressed, and stable emulsion polymerization is performable.

[Rosin Acid Soap]

In addition to (B) a sodium salt of a naphthalene sulfonate formaldehyde condensate and (C) sodium dodecylbenzenesulfonate, a commonly used rosin acid soap is preferably used as an emulsifier for the emulsion polymerization. The addition amount of the rosin acid soap is preferably 1.5 parts by mass or higher and 4.0 parts by mass or lower, more preferably 1.6 parts by mass or higher and 3.7 parts by mass or lower, and still more preferably 1.7 parts by mass or higher and 3.0 parts by mass or lower, relative to the total amount of (A-1) 2-chloro-1,3-butadiene (chloroprene), (A-2-1) 2,3-dichloro-1,3-butadiene, and (A-2-2) another monomer, namely the feed amount of all the monomers of 100 parts by mass. When the addition amount is within the above range, simple and convenient solidification operation is performable.

[Chloroprene Polymer Latex]

The latex of the chloroprene polymer is specifically (1) a homopolymer latex of (A-1) chloroprene, (2) a copolymer latex of (A-1) chloroprene and (A-2-1) 2,3-dichloro-1,3-butadiene, (3) a copolymer latex of (A-1) chloroprene, (A-2-1) 2,3-dichloro-1,3-butadiene, and (A 2-2) another monomer, or (4) a copolymer latex of (A-1) chloroprene and (A-2-2) another monomer, as described above.

With respect to the chloroprene polymer latex according to the present invention, additives such as an emulsifier, a chain transfer agent, and a stabilizer may be used in addition to the above (A) chloroprene-based copolymers depending on necessity, as long as the object of the present invention is not lost.

The chain transfer agent is not particularly limited and a xanthogendisulfide or an alkyl mercaptan may be used. The use amount of the chain transfer agent cannot be defined unconditionally since it is affected by the type thereof, the use amount of (A-2-1) 2,3-dichloro-1,3-butadiene, polymerization rate and polymerization temperature. However, when n-dodecyl mercaptan is used for example, the amount is preferably 0.03 parts by mass or higher and 0.2 parts by mass or lower, more preferably 0.06 parts by mass or higher and 0.15 parts by mass or lower, and still more preferably 0.08 parts by mass or higher and 0.13 parts by mass or lower, relative to the feed amount of all the monomers of 100 parts by mass.

[Method for Producing Chloroprene Polymer]

Polymerization Initiator:

A polymerization initiator is not particularly limited, and a generic radical polymerization initiator may be used. Particularly for emulsion polymerization, organic or inorganic peroxides such as benzoyl peroxide, potassium persulfate, and ammonium persulfate, and azo compounds such as azobisisobutyronitrile are preferred. Promoters such as anthraguinone sultanate, potassium sulfite, and sodium sulfite may be simultaneously used, if appropriate. Radical polymerization initiators and promoters may be used in combination of 2 or more thereof.

Polymerization Temperature:

The polymerization temperature to obtain the chloroprene polymer latex is preferably 30 to 55° C., more preferably 35 to 50° C., and particularly preferably 35 to 45° C. A polymerization temperature of 30° C. or lower is not preferred since the productivity of the (A) chloroprene copolymer may be reduced, the obtained latex may have insufficient adhesive strength, or a setting property may be deteriorated. If the polymerization temperature is higher than 55° C., the vapor pressure of (A-1) 2-chloro-1,3-butadiene (chloroprene) is high, causing great difficulty in the polymerization operation, and moreover, the obtained polymer may have insufficient mechanical properties such as tensile strength.

Solid Concentration of Chloroprene Polymer Latex:

The chloroprene copolymer latex according to the present invention ordinarily has a solid concentration of preferably 50 to 65% by mass, more preferably 52 to 60% by mass, and still more preferably 54 to 60% by mass. By making the solid concentration to be 50% by mass or higher, a chloroprene polymer latex having a high concentration per unit volume is obtainable, and reduced drying time and load on a drying device can be achieved. In addition, appropriate fluidity. is obtainable when the solid concentration is 65% by mass or lower.

Polymerization Terminator:

During the production of a chloroprene polymer latex, a polymerization terminator is ordinarily added to terminate the reaction when a predetermined polymerization rate is achieved, in order to obtain a polymer having an intended molecular weight and intended molecular weight distribution.

The polymerization terminator is not particularly limited and commonly used ones such as phenothiazine, para-t-butylcatechol, hydroquinone, hydroquinone monomethyl ether, and diethyl hydroxyl amine may be used.

### EXAMPLES

The present invention is described based on examples and comparative examples below, but is not limited thereto.

With respect to the chloroprene polymer latexes in the examples and comparative examples, polymerization conversion, solid content after polymerization, and incidence of aggregates were obtained by the following methods.

Solid Content after Polymerization and Polymerization Conversion:

A predetermined amount of an emulsion after polymerization was collected and the polymerization conversion was calculated from the solids after drying performed at a temperature of 141° C. for 30 minutes. The solid content after polymerization and the polymerization conversion were obtained by the following formulae:

Solid content after polymerization (% by mass)=[(mass after drying at 141° C. for 30 min.)/(mass of latex before drying)]×100

Polymerization conversion (%)=[(amount of generated polymer/feed amount of all the monomers)]×100

The amount of generated polymer was obtained by subtracting the solids other than the polymer from the solids after polymerization. For the solids other than the polymer, the amount of components not volatilizing under the conditions at 141° C. was calculated from the feed amount of polymerization raw materials.

Measurement of Incidence of Aggregates:

After the polymerization, 2 pieces of medical gauze (12 warp threads and 12 woof threads per centimeter) were layered and set to perform filtration, the residue was dried at a temperature of 70° C. in the air for 15 hours, and thereafter the mass was measured to obtain a mass ratio of aggregates to the feed amount of the monomers.

### Example 1

A reactor having an internal volume of 5 L was used. Into the reactor, 2.0 kg (100 parts by mass) of 2-chloro-1,3-butadiene (chloroprene) (produced by Tokyo Chemical Industry, Co., Ltd.), 1.04 kg (52 parts by mass) of pure water, 40 g (2 parts by mass) of a rosin acid (R-300, produced by Arakawa Chemical Industries, Ltd.), a chain transfer agent: 2 g (0.1 parts by mass) of n-dodecyl mercaptan (produced by Tokyo Chemical Industry, Co., Ltd.), 100 g (5 parts by mass) of a 20% mass aqueous potassium hydroxide solution (guaranteed reagent, produced by Wako Junyaku K.K.), 12.8 g (0.64 parts by mass) of a sodium salt of a β-naphthalene sulfonate formaldehyde condensate (produced by Kao Corporation), and 6.7 g (0.05 parts by mass as sodium dodecylbenzenesulfonate) of a 15% by mass aqueous solution of sodium dodecylbenzenesulfonate (Neopelex (registered trade name) G-15, produced by Kao Corporation) were fed and emulsified, and after the rosin acid was converted into a rosin acid soap, polymerization was performed in a nitrogen gas atmosphere at a temperature of 40° C., for 5 hours, using potassium persulfate (1^{st} grade, produced by Wako Junyaku K.K.) as an initiator. When the polymerization conversion was confirmed to be 94% or higher, the polymerization was terminated. Subsequently, unreacted monomers were eliminated via steam distillation to obtain a chloroprene polymer latex. The solid content after polymerization in the chloroprene polymer latex was 58.1%. Aggregate generation was not observed.

### Example 2

A chloroprene polymer latex was produced under the same conditions as described in Example 1 except for using 9.8 g (0.49 parts by mass) of a sodium salt of a β-naphthalene sulfonate formaldehyde condensate and 6.0 g (0.045 parts by mass as sodium dodecylbenzenesulfonate) of a 15% by mass aqueous solution of sodium dodecylbenzenesulfonate.

The polymerization conversion was 90%, and the solid content after polymerization in the polymer latex was 56.6%, Aggregate generation was not observed.

### Comparative Example 1

A chloroprene polymer latex was produced under the same conditions as described in Example 1 except for adding no sodium dodecylbenzenesulfonate and adding 16 g (0.80 parts by mass) of a sodium salt of a β-naphthalene sulfonate formaldehyde condensate.

The polymerization conversion was 93%, and the solid content after polymerization in the polymer latex was 56.1%. The incidence of aggregates was 0.6%.

### Comparative Example 2

A chloroprene polymer latex was produced under the same conditions as described in Example 1 except for adding no sodium dodecylbenzenesulfonate and adding 12.8 g (0.64 parts by mass) of a sodium salt of a β-naphthalene sulfonate formaldehyde condensate.

The polymerization conversion was 93%, the solid content after polymerization in the polymer latex was 56.9%, and the incidence of aggregates was 0.1%.

Results of Examples 1 and 2 and Comparative examples 1 and 2 are summarized in Table 1.

TABLE 1

| | | | Comparative | Comparative |
|---|---|---|---|---|
| | Example 1 | Example 2 | example 1 | example 2 |
| Chloroprene monomer¹⁾ (parts by mass) | 100 | 100 | 100 | 100 |
| Rosin acid²⁾ (parts by mass) | 2 | 2 | 2 | 2 |
| Chain transfer agent³⁾ (parts by mass) | 0.1 | 0.1 | 0.1 | 0.1 |
| Sodium salt of a naphthalene sulfonate | 0.64 | 0.49 | 0.80 | 0.64 |
| formaldehyde condensate⁴⁾ (parts by mass) | | | | |
| Sodium dodecylbenzenesulfonate⁵⁾ | 0.05 | 0.12 | — | — |
| Aggregate generation amount/monomer | 0 | 0 | 0.6 | 0.1 |
| feed amount (mass ratio) | | | | |
| Polymerization conversion % | 94 | 90 | 93 | 93 |
| Solid content (%) | 58.1 | 56.6 | 56.1 | 56.9 |

¹⁾Chloroprene (produced by Tokyo Chemical Industry, Co., Ltd.)
²⁾Rosin acid (R-300, produced by Arakawa Chemical Industries, Ltd.)
³⁾Chain transfer agent: n-dodecyl mercaptan (produced by Tokyo Chemical Industry, Co., Ltd.)
⁴⁾Sodium salt of a β-naphthalene sulfonate formaldehyde condensate (produced by Kao Corporation)
⁵⁾Sodium dodecylbenzenesulfonate (Neopelex (registered trade name) G-15, produced by Kao Corporation)

Aggregates were not generated in Examples 1 and 2 in which a sodium salt of a naphthalene sulfonate formaldehyde condensate and sodium dodecylbenzenesulfonate were added. In contrast, aggregates having adverse effects on productivity were generated in Comparative examples 1 and 2 in which sodium dodecylbenzenesulfonate was not used.

1. A method for producing a chloroprene polymer latex, comprising: adding (B) a sodium salt of a naphthalene sulfonate formaldehyde condensate and (C) sodium dodecylbenzenesulfonate to a monomer solution that contains (A-1) 2-chloro-1,3-butadiene (chloroprene) or a monomer solution that contains (A-1) 2-chloro-1,3-butadiene (chloroprene) and (A-2-1) 2,3-dichloro-1,3-butadiene, and performing emulsion polymerization.

2. The method for producing a chloroprene polymer latex according to claim 1, wherein the addition amount of the sodium salt of a naphthalene sulfonate formaldehyde condensate is 0.3 parts by mass or higher and 2.0 parts by mass or lower relative to the feed amount of all the monomers of 100 parts by mass.

3. The method for producing a chloroprene polymer latex according to claim 1, wherein the addition amount of sodium dodecylbenzenesulfonate is 0.01 parts by mass or higher and 0.2 parts by mass or lower relative to the feed amount of all the monomers of 100 parts by mass.

4. The method for producing a chloroprene polymer latex according to claim 1, wherein an anionic surfactant is used as an emulsifier.

5. The method for producing a chloroprene polymer latex according to claim 1, wherein a rosin acid soap that is a rosin acid saponified with an excess amount of sodium hydroxide and/or potassium hydroxide is used as an emulsifier.

6. The method for producing a chloroprene polymer latex according to claim 1, wherein the monomer solution further contains (A-2-2) another monomer that is copolymerizable with (A-1) 2-chloro-1,3-butadiene (chloroprene).

7. The method for producing a chloroprene polymer latex according to claim 2, wherein the addition amount of sodium dodecylbenzenesulfonate is 0.01 parts by mass or higher and 0.2 parts by mass or lower relative to the feed amount of all the monomers of 100 parts by mass.
